(19) United States
(12) Patent Application Publication
(10) Pub. No.: US 2025/0385277 A1
(43) Pub. Date: Dec. 18, 2025

(54) SEPARATOR FOR FUEL CELL

(71) Applicant: TOYOTA BOSHOKU KABUSHIKI KAISHA, Aichi-ken (JP)

(72) Inventors: Haruyuki AONO, Aichi-ken (JP); Kohei MINOSHIMA, Nagoya-shi (JP)

(73) Assignee: TOYOTA BOSHOKU KABUSHIKI KAISHA, Aichi-ken (JP)

(21) Appl. No.: 19/226,896

(22) Filed: Jun. 3, 2025

(30) Foreign Application Priority Data
Jun. 13, 2024 (JP) 2024-095893

(51) Int. Cl. H01M 8/026

(52) U.S. Cl. CPC H01M 8/026

(57) ABSTRACT

A separator for a fuel cell includes a body having ribs that extend parallel to each other. The ribs protrude from the body to come into contact with a gas diffusion layer of a membrane electrode gas diffusion layer assembly. The space between the ribs and between the separator and the gas diffusion layer defines a passage through which gas is supplied to and discharged from the membrane electrode gas diffusion layer assembly. An end face of each rib in a protruding direction is parallel to the gas diffusion layer. A protrusion protrudes from the end face of each rib toward the gas diffusion layer. The protrusion of each rib extends in a width direction of the rib to reach the passage.

### CROSS-REFERENCE TO RELATED APPLICATIONS

This application is based upon and claims the benefit of priority from Japanese Patent Application No. 2024-095893, filed on Jun. 13, 2024, the entire contents of which are incorporated herein by reference.

### BACKGROUND

### 1. Field

The present disclosure relates to a separator for a fuel cell.

### 2. Description of Related Art

A cell stack of a fuel cell is formed by stacking single cells in the thickness direction. Each single cell is formed by sandwiching a membrane electrode gas diffusion layer assembly with plate-shaped separators from the opposite sides in the thickness direction. The separator for a fuel cell disclosed in International Publication No. 2012/035584 includes a body having ribs that extend parallel to each other. The ribs protrude from the body to come into contact with the gas diffusion layer of the membrane electrode gas diffusion layer assembly. The space between the ribs and between the separator and the gas diffusion layer defines a passage through which gas is supplied to and discharged from the membrane electrode gas diffusion layer assembly.

Fuel gas (e.g., hydrogen) is supplied to the passage between the gas diffusion layer on the anode side and the separator on the anode side of the opposite sides of the membrane electrode gas diffusion layer assembly in the thickness direction. Oxidant gas (e.g., air) is supplied to the passage between the gas diffusion layer on the cathode side and the separator on the cathode side of the opposite sides of the membrane electrode gas diffusion layer assembly in the thickness direction. In the single cell, power is generated from the reaction between the fuel gas and the oxidant gas at the membrane electrode gas diffusion layer assembly. The gas diffusion layer of the membrane electrode gas diffusion layer assembly diffuses the gas supplied to the membrane electrode gas diffusion layer assembly from the passage, resulting in uniform distribution of the gas to the membrane electrode gas diffusion layer assembly.

In the fuel cell separator disclosed in the publication, the end faces of the ribs in the protruding direction are in contact with the gas diffusion layer of the membrane electrode gas diffusion layer assembly. At the portions of the gas diffusion layer that are in contact with the end faces of the ribs, it becomes difficult for the gas flowing through the passage to reach the gas diffusion layer, resulting in reduced gas diffusion efficiency. Thus, a groove connecting to the passage on the end face of each rib is formed so that the gas flowing through the passage readily reaches, from the groove, the portion of the gas diffusion layer in contact with the end face of the rib.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

To enhance the gas diffusion efficiency at the portion of the gas diffusion layer in contact with the end faces of the ribs, it is effective for the gas to reach multiple positions in that portion. However, as described above, when a groove is formed in the end face of each rib, the gas can reach that portion only from the groove. Therefore, even if a groove is formed in the end face of the rib, the gas diffusion efficiency can be improved to a limited extent at the portion of the gas diffusion layer in contact with the end face of the rib.

A separator for a fuel cell according to an aspect of the present disclosure includes a body including ribs that extend in parallel to each other. The body is configured to be located on one of two sides of a membrane electrode gas diffusion layer assembly in a thickness direction. The ribs protrude from the body to come into contact with a gas diffusion layer of the membrane electrode gas diffusion layer assembly. A space between the ribs and between the separator and the gas diffusion layer defines a passage through which gas is supplied to and discharged from the membrane electrode gas diffusion layer assembly. An end face of each of the ribs in a protruding direction is parallel to the gas diffusion layer. A protrusion protrudes from the end face of each of the ribs toward the gas diffusion layer. The protrusion of each of the ribs extends in a width direction of the rib to reach the passage.

Other features and aspects will be apparent from the following detailed description, the drawings, and the claims.

### BRIEF DESCRIPTION OF THE DRAWINGS

FIG. 1 is an exploded perspective view of a single cell for a fuel cell.

FIG. 2 is a cross-sectional view of the cell stack in which the single cells of FIG. 1 are stacked.

FIG. 3 is a perspective view illustrating the separator of each single cell shown in FIG. 2.

FIG. 4 is a cross-sectional view of the separator shown in FIG. 3, taken along line 4-4.

FIG. 5 is a plan view illustrating the positions of the protrusions formed on the ribs in the separator of FIG. 3.

FIG. 6 is a plan view illustrating another example of the positions of the protrusions formed on the ribs in the separator.

FIG. 7 is a plan view illustrating another example of the positions of the protrusions formed on the ribs in the separator.

FIG. 8 is a plan view illustrating another example of the positions of the protrusions formed on the ribs in the separator.

FIG. 9 is a plan view illustrating another example of the positions and extending directions of the protrusions formed on the ribs in the separator.

FIG. 10 is a plan view illustrating another example of the positions and extending directions of the protrusions formed on the ribs in the separator.

FIG. 11 is a plan view illustrating another example of the positions and extending directions of the protrusions formed on the ribs in the separator.

FIG. 12 is a plan view illustrating another example of the positions and extending directions of the protrusions formed on the ribs in the separator.

FIG. 13 is a plan view illustrating another example of the positions and extending directions of the protrusions formed on the ribs in the separator.

FIG. 14 is a plan view illustrating another example of the positions of the protrusions formed on the ribs in the separator.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

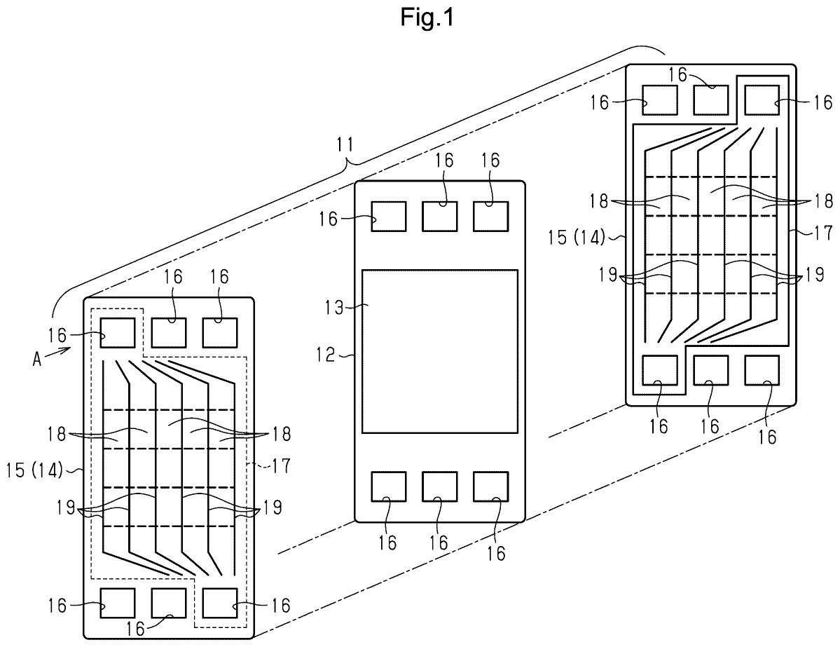

A separator for a fuel cell according to an embodiment will now be described with reference to FIGS. 1 to 5.

FIG. 1 shows a single cell 11 used to form a cell stack of a fuel cell. The single cell 11 includes a plastic plate 12, a membrane electrode gas diffusion layer assembly 13, and two separators 14. The plastic plate 12 has the shape of a rectangular frame. The outer edge of the membrane electrode gas diffusion layer assembly 13 is joined to the plastic plate 12. The plastic plate 12 and the membrane electrode gas diffusion layer assembly 13 are sandwiched by the separators 14, which are respectively arranged on the opposite sides in the thickness direction.

The cell stack of the fuel cell is formed by stacking multiple single cells 11 in the thickness direction. The plastic plates 12 and the separators 14 of the single cells 11 each have holes 16. Three of the holes 16 are located at one end of the single cell 11 in the long-side direction, and the other three are located at the other end of the single cell 11 in the long-side direction. One of the holes 16 at the one end in the long-side direction of the single cell 11 is paired with one of the holes 16 at the other end. Fluid (e.g., fuel gas such as hydrogen, oxidant gas such as air, and refrigerant such as coolant) flows through each pair of the holes 16.

The separators 14 include a body 15 that is made of metal (e.g., stainless steel, titanium, or aluminum) and formed to have the shape of a rectangular plate. The body 15 includes ribs 19 that are parallel to each other and extend in the long-side direction. A seal member 17 is arranged between the body 15 of each separator 14 and the plastic plate 12. The seal members 17 can be disposed on the surfaces of the plastic plate 12 on the opposite sides in the thickness direction.

The seal member 17 arranged on the front side of the plastic plate 12 surrounds pairs of the holes 16, each pair being positioned along one of the two diagonal lines of the plastic plate 12 and the corresponding separator 14, and surrounds the anode side of the membrane electrode gas diffusion layer assembly 13. The seal member 17 also surrounds the ribs 19 in the anode-side separator 14. Further, a passage 18 through which fuel gas flows is defined between adjacent ones of the ribs 19 in the separator 14. Fuel gas can be supplied to the passages 18 through the pair of holes 16. The upstream end of each passage 18 in the flow of fuel gas, which connects to the hole 16 to which the fuel gas is supplied, acts as the inlet for the fuel gas in the passage 18. The downstream end of each passage 18 in the flow of fuel gas, which connects to the hole 16 from which the fuel gas is discharged, acts as the outlet for the fuel gas in the passage 18.

The seal member 17 arranged on the rear side of the plastic plate 12 surrounds pairs of the holes 16, each pair being positioned along the other one of the two diagonal lines of the plastic plate 12 and the corresponding separator 14, and surrounds the cathode side of the membrane electrode gas diffusion layer assembly 13. The seal member 17 also surrounds the ribs 19 in the cathode-side separator 14. Further, a passage 18 through which oxidant gas flows is defined between adjacent ones of the ribs 19 in the separator 14. Oxidant gas can be supplied to the passages 18 through the pair of holes 16. The upstream end of each passage 18 in the flow of oxidant gas, which connects to the hole 16 to which the oxidant gas is supplied, acts as the inlet for the oxidant gas in the passage 18. The downstream end of each passage 18 in the flow of oxidant gas, which connects to the hole 16 from which the oxidant gas is discharged, acts as the outlet for the oxidant gas in the passage 18.

In the fuel cell stack of the stacked single cells 11, the fuel gas flows along the anode side of the membrane electrode gas diffusion layer assembly 13, and the oxidant gas flows along the cathode side of the membrane electrode gas diffusion layer assembly 13. When the fuel gas and the oxidant gas respectively flow along the anode side and the cathode side of the membrane electrode gas diffusion layer assembly 13 in this manner, power is generated from the reaction between the fuel gas and the oxidant gas in the membrane electrode gas diffusion layer assembly 13.

### Structure Surrounding the Area of Ribs 19 and Passages 18 in the Separator 14

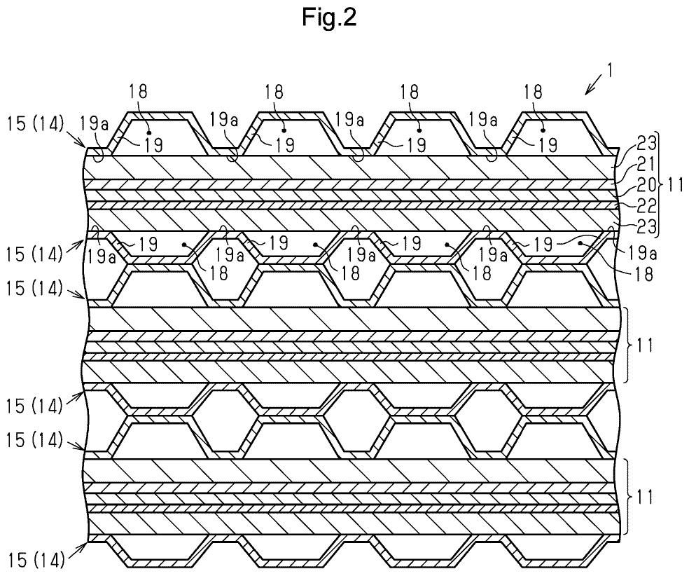

As shown in FIG. 2, the membrane electrode gas diffusion layer assembly 13 of each single cell 11 includes an electrolyte layer 20, a cathode electrode layer 21, an anode electrode layer 22, and a gas diffusion layer 23. The electrolyte layer 20 is formed by, for example, a solid polymer membrane. The cathode electrode layer 21 is bonded to one side of the electrolyte layer 20 in the thickness direction (the upper side in FIG. 1). The anode electrode layer 22 is bonded to the other side in the thickness direction of the electrolyte layer 20 (the lower side in FIG. 1). The surface of the cathode electrode layer 21 opposite the electrolyte layer 20 is covered by the gas diffusion layer 23. The surface of the anode electrode layer 22 opposite the electrolyte layer 20 is covered by another gas diffusion layer 23, which is different from the aforementioned gas diffusion layer 23.

Two separators 14 are respectively located on the cathode side and the anode side of the membrane electrode gas diffusion layer assembly 13. That is, each separator 14 is configured to be located on one of the two sides of the membrane electrode gas diffusion layer assembly 13 in the thickness direction. Multiple ribs 19 on the cathode-side separator 14 are formed by bending the body 15 so as to protrude toward the cathode-side gas diffusion layer 23. These ribs 19 are in contact with the cathode-side gas diffusion layer 23. End faces 19a of the ribs 19, which are formed in a direction protruding from the body 15, are parallel to the cathode-side gas diffusion layer 23. The space between the ribs 19 of the separator 14 and between the separator 14 and the gas diffusion layer 23 defines passages 18 through which oxidant gas flows.

Multiple ribs 19 on the anode-side separator 14 are formed by bending the body 15 so as to protrude toward the anode-side gas diffusion layer 23. These ribs 19 are in contact with the anode-side gas diffusion layer 23. End faces 19a of the ribs 19, which are formed in a direction protruding from the body 15, are parallel to the anode-side gas diffusion layer 23. The space between the ribs 19 of the separator 14 and between the separator 14 and the gas diffusion layer 23 defines passages 18 through which fuel gas flows.

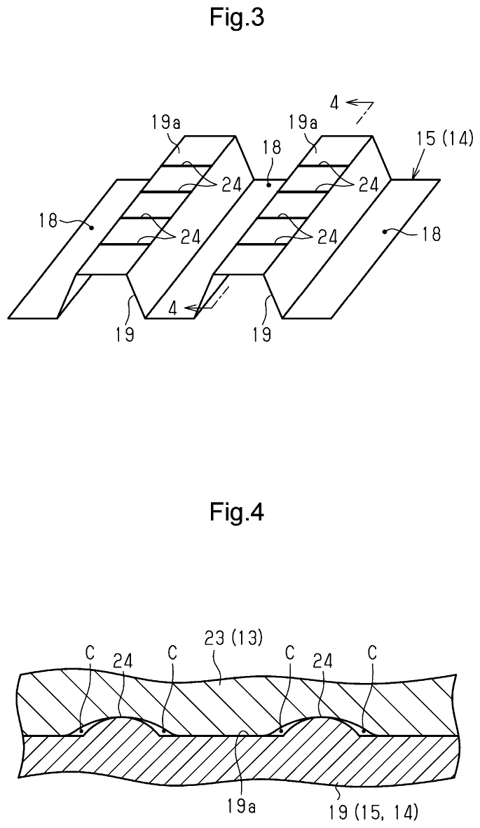

As shown in FIGS. 3 and 4, protrusions 24 protrude from the end face 19a of each rib 19 in the separator 14, which is oriented in the protruding direction, toward the gas diffusion layer 23 shown in FIG. 4. Each protrusion 24 extends across the entire rib 19 in the width direction to reach its adjacent passages 18. The end face 19a of the rib 19 and the protrusion 24 formed on that end face 19a are pressed against the gas diffusion layer 23. As shown in FIG. 4, when the protrusion 24 is pressed against the gas diffusion layer 23, clearances C are formed at the basal end of the protrusion 24 in the protruding direction from the end face 19a. The clearances C are located between the basal end and the gas diffusion layer 23. The clearances C are formed on the opposite sides of the basal end of the protrusion 24 in the width direction. The clearances C extend along the protrusion 24 and are each connected to its adjacent passages 18 shown in FIG. 3.

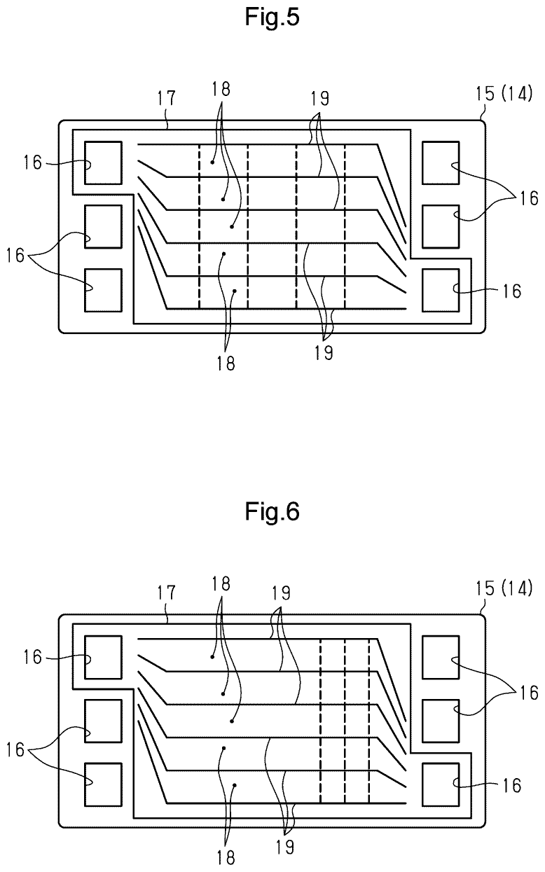

The broken lines in FIG. 5 indicate the positions of the protrusions 24 on the ribs 19. As shown in the broken line in FIG. 5, multiple protrusions 24 are formed at intervals defined in the extending direction of the ribs 19 (e.g., at regular intervals). As shown in FIG. 3, the protrusions 24 formed on the end face 19a of a rib 19 and the protrusions 24 formed on the end face 19a of another rib 19 adjacent to that rib 19 are located on the same straight line, which is orthogonal to the extending direction of the ribs 19. The ribs 19 may be formed through, for example, laser processing.

### Operational Advantages of Separator 14

The operational advantages of the separator 14 for the fuel cell according to the present embodiment will now be described.

(1) The end faces 19a of the ribs 19 on the separator 14 and the protrusions 24 formed on the end faces 19a are pressed against the gas diffusion layer 23 to create the clearances C between the basal ends of the protrusions 24 in the protruding direction and the gas diffusion layer 23. The clearances C are formed on the opposite sides of the basal end of each protrusion 24 in the width direction, and extend along the protrusion 24 to the passages 18. As a result, the clearances C allow the gas flowing through the passages 18 to readily reach the portion of the gas diffusion layer 23 in contact with the end faces 19a of the ribs 19. As described above, two clearances C are formed in one protrusion 24. Accordingly, gas readily reaches the portion of the gas diffusion layer 23 in contact with the end faces 19a of the ribs 19 at a larger number of positions. Thus, the gas diffusion efficiency is further improved at the portion of the gas diffusion layer 23 in contact with the end faces 19a of the ribs 19.

(2) If the protrusion 24 is formed using the mold for the separator 14, the cost of the mold would be relatively high. However, the protrusion 24 on the end face 19a of the rib 19 is formed through laser processing. This limits an increase in the mold cost.

(3) The protrusions 24 formed on the end face 19a of each of adjacent ones of the ribs 19 are located on the same straight line. This facilitates the formation of the protrusions 24 through laser processing. In other words, when the protrusions 24 are formed through laser processing, the movement of the laser head used for laser processing is linear, which facilitates the formation of the protrusions 24.

The above-described embodiment may be modified as follows. The above-described embodiment and the following modifications can be combined as long as the combined modifications remain technically consistent with each other.

The protrusions 24 do not have to extend across the entire rib 19 in the width direction, and may extend to only one of adjacent passages 18.

As shown by the broken line in FIG. 6, the protrusions 24 may be positioned toward the outlet of each passage 18 in the body 15, i.e., toward the right side in FIG. 6, in the direction in which the ribs 19 extend. As the gas flowing through each passage 18 approaches the outlet of the passage 18, the components used for power generation decreases. Thus, in terms of power generation, it is preferred that the gas diffusion efficiency be increased toward the outlet of the passage 18 in the gas diffusion layer 23. Since the protrusions 24 are positioned toward the outlet of the passage 18 in the extending direction of the rib 19, the clearances C formed by the protrusion 24 between the gas diffusion layer 23 and the end face 19a of the rib 19 are also positioned toward the outlet of the passage 18. Thus, at the portion of the gas diffusion layer 23 that is in contact with the end face 19a of the rib 19 and is positioned toward the outlet of the passage 18, the gas diffusion efficiency increases.

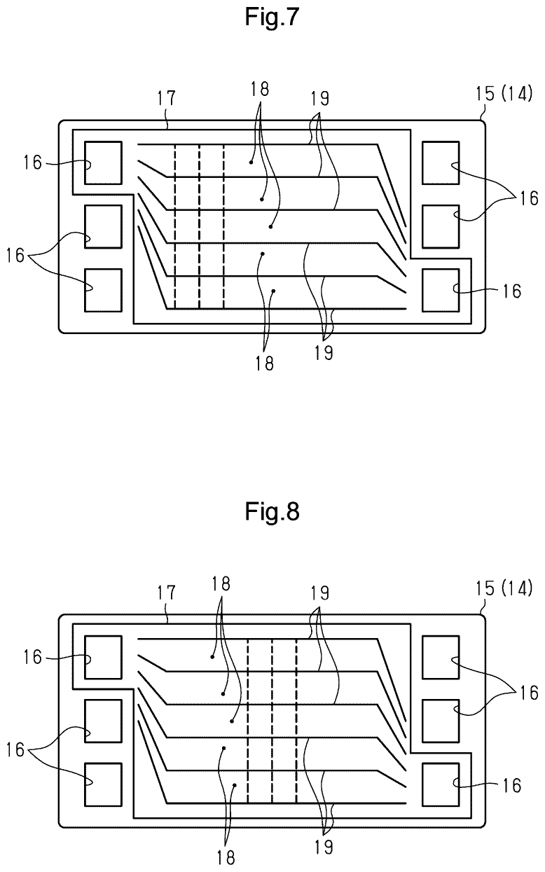

As shown by the broken line in FIG. 7, the protrusions 24 may be positioned toward the inlet of each passage 18 in the body 15, i.e., toward the left side in FIG. 8, in the direction in which the ribs 19 extend. The pressure loss resulting from the passage of gas through the passage 18 increases toward the inlet of the passage 18. However, when the ribs 19 are formed in the above-described manner, the clearances C are formed at the basal end of each protrusion 24 in the protruding direction. This limits an increase in the pressure loss at the portion of the body 15 positioned toward the inlet of the passage 18.

As shown by the broken lines in FIG. 8, the protrusions 24 may be formed at intermediate positions between the inlet and the outlet of each passage 18 in the direction in which the rib 19 extends.

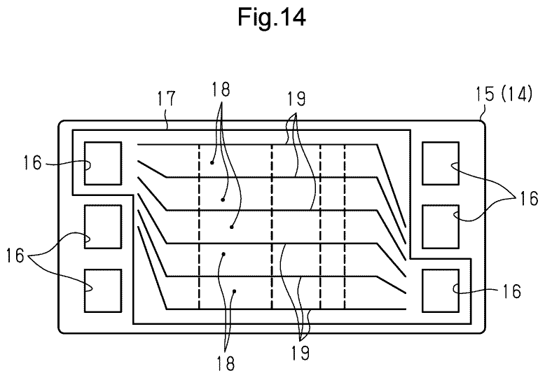

As shown by the broken lines in FIG. 14, multiple protrusions 24 formed on the end face 19a of each rib 19 may have shorter intervals between each other toward the outlet of the passage 18 in the body 15 (i.e., toward the right side of FIG. 14).

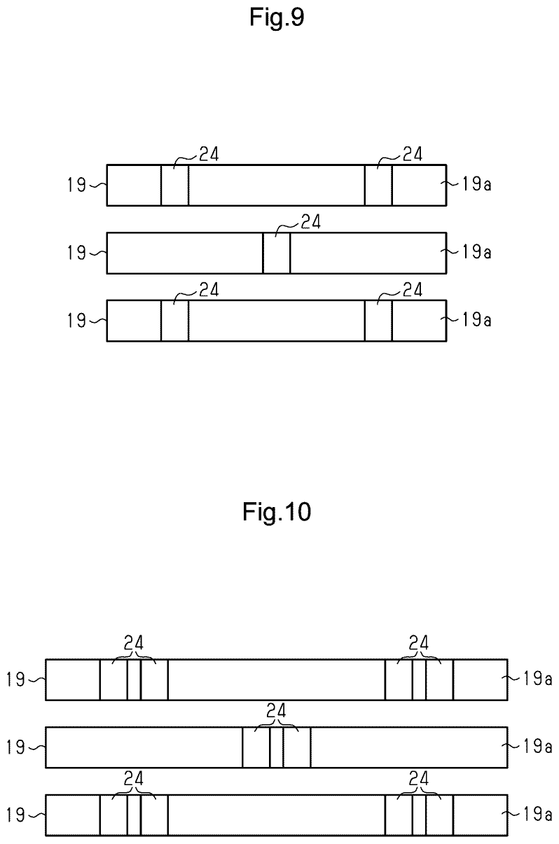

The protrusions 24 may be arranged in each of the ribs 19 as shown in FIGS. 9 and 10.

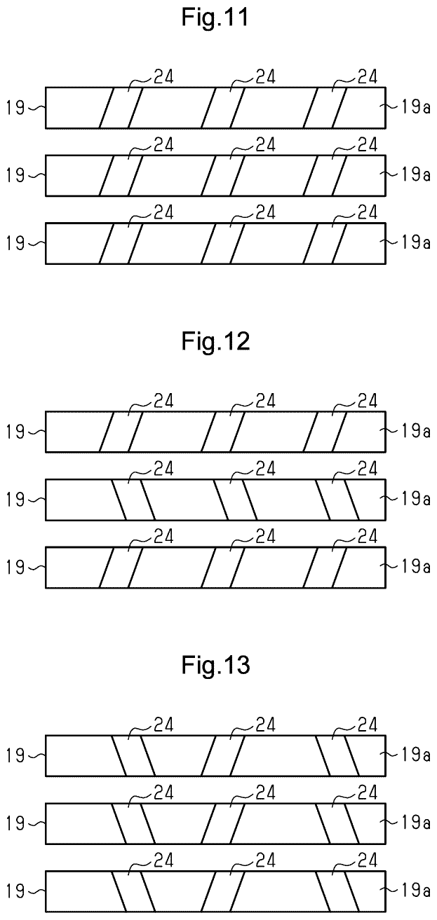

As shown in FIGS. 11 to 13, the protrusions 24 may extend over each rib 19 in the width direction and be inclined relative to the extending direction of the rib 19. In this case, one end of each protrusion 24 in its extending direction is located upstream of the other end in the passage 18. This causes the clearances C, which are located at the basal end of the protrusion 24 in the projection direction, to facilitate the flow of gas from the passage 18. As a result, the gas diffusion efficiency is increased more easily at the portion of the gas diffusion layer 23 in contact with the end faces 19a of the ribs 19.

When the protrusions 24 are inclined relative to the extending direction of each rib 19 as shown in FIG. 11, the protrusions 24 of adjacent ones of the ribs 19 may extend on the same straight line that is inclined relative to the extending direction of the rib 19.

The protrusions 24 may be formed using a mold for the separator 14.

The material used to form the separator 14 may be changed.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A separator for a fuel cell, the separator comprising:
a body including ribs that extend in parallel to each other, wherein
the body is configured to be located on one of two sides of a membrane electrode gas diffusion layer assembly in a thickness direction,
the ribs protrude from the body to come into contact with a gas diffusion layer of the membrane electrode gas diffusion layer assembly,
a space between the ribs and between the separator and the gas diffusion layer defines a passage through which gas is supplied to and discharged from the membrane electrode gas diffusion layer assembly,
an end face of each of the ribs in a protruding direction is parallel to the gas diffusion layer,
a protrusion protrudes from the end face of each of the ribs toward the gas diffusion layer, and
the protrusion of each of the ribs extends in a width direction of the rib to reach the passage.

2. The separator for the fuel cell according to claim 1, wherein
the body includes an inlet and an outlet for the gas to pass through the passage, and
the protrusion of each of the ribs is positioned toward the outlet of the body in a direction in which the rib extends.

3. The separator for the fuel cell according to claim 1, wherein
the body includes an inlet and an outlet for the gas to pass through the passage,
the protrusion of each of the ribs is one of multiple protrusions formed on the end face at predetermined intervals in a direction in which the rib extends, and
the intervals between the protrusions of each of the ribs become shorter as the protrusions become closer to the outlet of the body.

4. The separator for the fuel cell according to claim 1, wherein
the protrusion of each of the ribs extends across the rib in the width direction, and extends so as to incline relative to a direction in which the rib extends.

5. The separator for the fuel cell according to claim 1, wherein
the protrusion of each of the ribs is formed through laser processing.

6. The separator for the fuel cell according to claim 1, wherein
the protrusion of each of the ribs and the protrusion of another one of the ribs located adjacent to the each of the ribs are located on the same straight line.
